(19) United States
(12) Patent Application Publication
(10) Pub. No.: US 2025/0097786 A1
(43) Pub. Date: Mar. 20, 2025

(54) ENHANCEMENTS ON SLICE SERVICE CONTINUITY

(71) Applicant: Nokia Technologies Oy, Espoo (FI)

(72) Inventors: Halit Murat GÜRSU, Munich (DE); Philippe GODIN, Versailles (FR); Ahmad AWADA, Munich (DE); Muhammad NASEER-UL-ISLAM, Munich (DE); Ömer BULAKCI, Munich (DE); Ugur Baran ELMALI, Munich (DE)

(21) Appl. No.: 18/725,889

(22) PCT Filed: Jan. 5, 2022
(86) PCT No.: PCT/EP2022/050168

§ 371 Date: Jul. 1, 2024

(51) Int. Cl. H04W 36/00; H04W 36/08; H04W 36/24

(52) U.S. Cl. CPC H04W 36/0061; H04W 36/0058; H04W 36/0079; H04W 36/08; H04W 36/249

(57) ABSTRACT

Methods, devices, apparatuses, and computer readable medium for enhancements on service continuity. The method includes receiving, at a source network node and from a user equipment, UE, being served by the source network node for a service associated with a network slice, a message indicative of a target network node for a handover of the UE from the source network node to the target network node; transmitting a handover request to the target network node, the handover request indicating urgency of the handover for the UE, and the target network node being overloaded for the network slice; and receiving a handover request acknowledgement message from the target network node, the handover request acknowledgement message indicating if multi-carrier radio resource sharing is applicable for supporting the service.

### FIELD

Embodiments of the present disclosure generally relate to the field of telecommunication and in particular, to devices, methods, apparatus and computer readable storage media of enhancements on slice service continuity.

### BACKGROUND

Network slicing is one of the key 5G features to support different services using the same underlying mobile network infrastructure. Network slices may differ from service requirements, such as, Ultra-Reliable Low Latency Communication (URLLC), enhanced Mobile Broadband (eMBB), etc., or the tenants that provides such services. A network slice is uniquely identified via Single-Network Slice Selection Assistance Information (S-NSSAI). According to the current specifications, a UE is allowed to be simultaneously connected and served by at most eight network slices corresponding to eight S-NSSAIs. On the other hand, each cell may support tens or even hundreds of S-NSSAIs.

According to current specifications, a registration area (RA) corresponds to a list of tracking areas (TAs) that support the same network slices from the UE perspective, and each TA may support up to 1024 network slices. Considering the mobility of UE, one or more handover (HO) procedures may be performed within a RA or between different RAs. Moreover, network slice remapping may occur along with UE's mobility. This may challenge the service continuity. For example, in a case where a network slice at the target node that supports the ongoing service for the UE is overloaded, the service may be interrupted due to the handover. In order to ensure service continuity during the handover, it has been proposed to utilize the multi-carrier radio resource sharing in the above scenario.

### SUMMARY

In general, example embodiments of the present disclosure provide a solution for slice service continuity.

In a first aspect, there is provided a source network node. The source network node comprises: at least one processor; and at least one memory including computer program codes. The at least one memory and the computer program codes are configured to, with the at least one processor, cause the source network node at least to: receive, from a user equipment, UE, being served by the source network node for a service associated with a network slice, a message indicative of a target network node for a handover of the UE from the source network node to the target network node; transmit a handover request to the target network node, the handover request indicating urgency of the handover for the UE, and the target network node being overloaded for the network slice; and receive a handover request acknowledgement message from the target network node, the handover request acknowledgement message indicating if multi-carrier radio resource sharing is applicable for supporting the service.

In a second aspect, there is provided a target network node. The target network node comprises: at least one processor; and at least one memory including computer program codes. The at least one memory and the computer program codes are configured to, with the at least one processor, cause the target network node at least to: receive, from a source network node serving a user equipment, UE, for a service associated with a network slice, a handover request indicating urgency of the handover for the UE, the target network node being overloaded for the network slice; determine whether or not to apply multi-carrier radio resource sharing for supporting the service based on the urgency of the handover; and transmit, to the source network node, a handover request acknowledgement message indicating if the multi-carrier radio resource sharing is applicable for the service.

In a third aspect, there is provided a source network node. The source network node comprises: at least one processor; and at least one memory including computer program codes. The at least one memory and the computer program codes are configured to, with the at least one processor, cause the source network node at least to: receive, from a user equipment, UE, being served by the source network node for a service associated with a network slice, a message indicative of a target network node for a handover of the UE from the source network node to the target network node; transmit, to the target network node, a first handover request indicating a first serving cell of the target network node for supporting the network slice; upon receipt a first handover request acknowledgement message from the target network node, determine that the service is not supported in the first serving cell based on an indication of the first handover request acknowledgement; transmit, to the target network node, a second handover request indicating a second serving cell for supporting the network slice; and receive, from the target network node, a second handover request acknowledgement message comprising a handover configuration corresponding to the second serving cell supporting the network slice.

In a fourth aspect, there is provided a target network node. The target network node comprises: at least one processor; and at least one memory including computer program codes. The at least one memory and the computer program codes are configured to, with the at least one processor, cause the target network node at least to: receive, from a source network node serving a user equipment, UE, for a service associated with a network slice, a first handover request indicating a first serving cell of the target network node for supporting the network slice; transmit, to the source network node, a first handover request acknowledgement message including an indication indicating the service associated with the network slice not to be supported in the first serving cell with the network slice; receive, from the source network node, a second handover request indicating a second serving cell for supporting the network slice; and transmit, to the source network node, a second handover request acknowledgement message comprising a handover configuration corresponding to the second serving cell supporting the network slice.

In a fifth aspect, there is provided a user equipment (UE). The UE comprises: at least one processor; and at least one memory including computer program codes. The at least one memory and the computer program codes are configured to, with the at least one processor, cause the UE at least to: transmit, to a source network node serving the UE for a service associated with a network slice, a message indicative of a target network node for a handover of the UE from the source network node to the target network node for the service; receive, from the source network node, a handover command indicating continuity of the service via multi-carrier radio resource sharing; and receive the service via a serving cell using multi-carrier radio resource sharing based on the handover command.

In a sixth aspect, there is provided a method. The method comprises: receiving, at a source network node and from a user equipment, UE, being served by the source network node for a service associated with a network slice, a message indicative of a target network node for a handover of the UE from the source network node to the target network node; transmitting a handover request to the target network node, the handover request indicating urgency of the handover for the UE, and the target network node being overloaded for the network slice; and receiving a handover request acknowledgement message from the target network node, the handover request acknowledgement message indicating if multi-carrier radio resource sharing is applicable for supporting the service.

In a seventh aspect, there is provided a method. The method comprises: receiving, at a target network node and from a source network node serving a user equipment, UE, for a service associated with a network slice, a handover request indicating urgency of the handover for the UE, the target network node being overloaded for the network slice; determining whether or not to apply multi-carrier radio resource sharing for supporting the service based on the urgency of the handover; and transmitting, to the source network node, a handover request acknowledgement message indicating if the multi-carrier radio resource sharing is applicable for the service.

In an eighth aspect, there is provided a method. The method comprises: receiving, at a source network node and from a user equipment, UE, being served by the source network node for a service associated with a network slice, a message indicative of a target network node for a handover of the UE from the source network node to the target network node; transmitting, to the target network node, a first handover request indicating a first serving cell of the target network node for supporting the network slice; upon receipt a first handover request acknowledgement message from the target network node, determining that the service is not supported in the first serving cell based on an indication of the first handover request acknowledgement message; transmitting to the target network node, a second handover request indicating a second serving cell for supporting the network slice; and receiving, from the target network node, a second handover request acknowledgement message comprising a handover configuration corresponding to the second serving cell supporting the network slice.

In a ninth aspect, there is provided a method. The method comprises: receiving, at a target network node and from a source network node serving a user equipment, UE, for a service associated with a network slice, a first handover request indicating a first serving cell of the target network node for supporting the network slice; transmitting, to the source network node, a first handover request acknowledgement message including an indication indicating the service not to be supported in the first serving cell associated with the network slice; receiving, from the source network node, a second handover request indicating a second serving cell for supporting the network slice; and transmitting, to the source network node, a second handover request acknowledgement message comprising a handover configuration corresponding to the second serving cell supporting the network slice.

In a tenth aspect, there is provided a method. The method comprises: transmitting, at a user equipment, UE, and to a source network node serving the UE for a service associated with a network slice, a message indicative of a target network node for a handover of the UE from the source network node to the target network node for the service; receiving, from the source network node, a handover command indicating continuity of the service via multi-carrier radio resource sharing; and receiving the service via a serving cell using multi-carrier radio resource sharing based on the handover command.

In an eleventh aspect, there is provided a source apparatus. The source apparatus comprises: means for receiving, from a user equipment, UE, being served by the source apparatus for a service associated with a network slice, a message indicative of a target apparatus for a handover of the UE from the source apparatus to the target apparatus; means for transmitting a handover request to the target apparatus, the handover request indicating urgency of the handover for the UE, and the target apparatus being overloaded for the network slice; and means for receiving a handover request acknowledgement message from the target apparatus, the handover request acknowledgement message indicating if multi-carrier radio resource sharing is applicable for supporting the service.

In a twelfth aspect, there is provided a target apparatus. The target apparatus comprises: means for receiving, from a source apparatus serving a user equipment, UE, for a service associated with a network slice, a handover request indicating urgency of the handover for the UE, the target apparatus being overloaded for the network slice; means for determining whether or not to apply multi-carrier radio resource sharing for supporting the service based on the urgency of the handover; and means for transmitting, to the source apparatus, a handover request acknowledgement message indicating if the multi-carrier radio resource sharing is applicable for the service.

In a thirteen aspect, there is provided a source apparatus. The source apparatus comprises: means for receiving, from a user equipment, UE, being served by the source apparatus for a service associated with a network slice, a message indicative of a target apparatus for a handover of the UE from the source apparatus to the target apparatus; means for transmitting, to the target apparatus, a first handover request indicating a first serving cell of the target apparatus for supporting the network slice; means for upon receipt a first handover request acknowledgement message from the target apparatus, determining that the service is not supported in the first serving cell based on an indication of the first handover request acknowledgement message; means for transmitting to the target apparatus, a second handover request indicating a second serving cell for supporting the network slice; and means for receiving, from the target apparatus, a second handover request acknowledgement message comprising a handover configuration corresponding to the second serving cell.

In a fourteen aspect, there is provided a target apparatus. The target apparatus comprises: means for receiving, at a target apparatus and from a source apparatus serving a user equipment, UE, for a service associated with a network slice, a first handover request indicating a first serving cell of the target apparatus for supporting the network slice; means for transmitting, to the source apparatus, a first handover request acknowledgement message including an indication indicative of the service associated with the network slice not to be supported in the first serving cell; means for receiving, from the source apparatus, a second handover request indicating a second serving cell for supporting the network slice; and means for transmitting, to the source apparatus, a second handover request acknowledgement message comprising a handover configuration corresponding to the second serving cell supporting the network slice.

In a fifteen aspect, there is provided a non-transitory computer readable medium. The non-transitory computer readable medium comprises program instructions for causing an apparatus to perform the method according to the sixth aspect. In a sixteen aspect, there is provided a non-transitory computer readable medium.

The non-transitory computer readable medium comprises program instructions for causing an apparatus to perform the method according to the seventh aspect.

In a seventh aspect, there is provided a non-transitory computer readable medium. The non-transitory computer readable medium comprises program instructions for causing an apparatus to perform the method according to the eighth aspect.

In an eighteen aspect, there is provided a non-transitory computer readable medium. The non-transitory computer readable medium comprises program instructions for causing an apparatus to perform the method according to the ninth aspect.

In a nineteen aspect, there is provided a non-transitory computer readable medium. The non-transitory computer readable medium comprises program instructions for causing an apparatus to perform the method according to the tenth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A and 1B illustrate example service interruption scenarios due to overload of the target cell;

FIG. 2 illustrates an example network environment in which example embodiments of the present disclosure can be implemented;

FIG. 3A shows a signaling chart illustrating a handover procedure according to some example embodiments of the present disclosure;

FIG. 3B show a signaling chart illustrating a handover procedure according to some example embodiments of the present disclosure;

FIG. 4 illustrates a flowchart of an example method for slice service continuity according to example embodiments of the present disclosure;

FIG. 5 illustrates a flowchart of an example method for slice service continuity according to example embodiments of the present disclosure;

FIG. 6 illustrates a flowchart of an example method for slice service continuity according to example embodiments of the present disclosure;

FIG. 7 illustrates a flowchart of an example method for slice service continuity according to example embodiments of the present disclosure

FIG. 8 illustrates a flowchart of an example method for slice service continuity according to example embodiments of the present disclosure;

FIG. 9 illustrates a simplified block diagram of an apparatus that is suitable for implementing example embodiments of the present disclosure; and

FIG. 10 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Non-terrestrial network (NTN), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The network device is allowed to be defined as part of a gNB such as for example in CU/DU split in which case the network device is defined to be either a gNB-CU or a gNB-DU. A node may be considered to be an entity that may comprise one or more network functions (NFs). An NF may comprise one or more microservices. Microservices could be understood as more modular services (as compared with services produced/provided by NFs) that come together to provide a meaningful service/application. In this scope, one can deploy and scale the small modules flexibly (e.g., within a NF or between various NFs). For example, an NF can provide one or more services, and a microservice can represent small modules that make up the services in the NF. Moreover, microservices can communicate with each other, e.g., statelessly.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As previously mentioned, network slice remapping may occur along with UE's mobility. For example, if the ongoing slice is overloaded, the UE's current slice may be remapped to the other one. This can be the case in the current cell of the UE, where the UE's current ongoing slice gets overloaded, or when the UE is handed over from a source cell to a target cell, where the UE's current ongoing slice is overloaded in the target cell. This may cause the service interruption and/or an undesirable delay of handover.

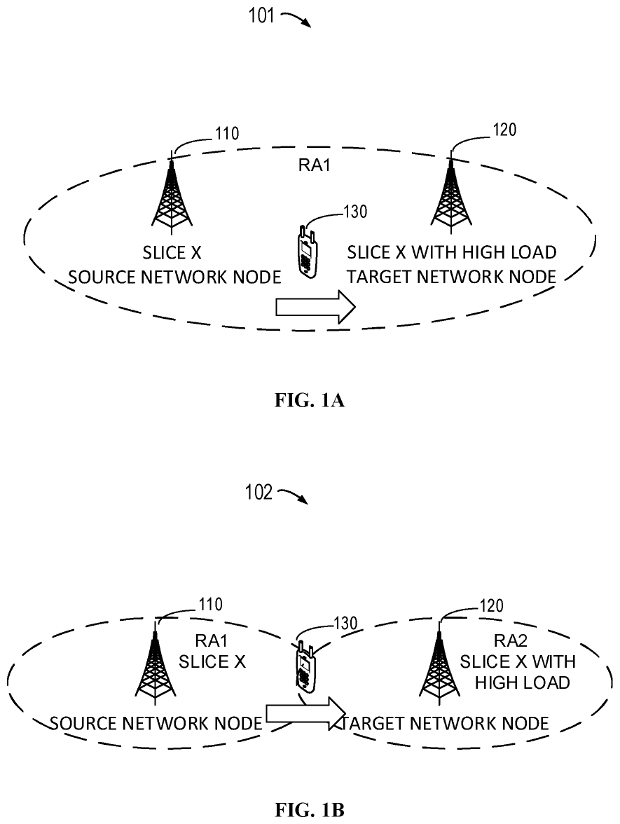

FIGS. 1A and 1B illustrate example service interruption scenarios 101 and 102 due to overload of the target cell. In scenario 101 as shown in FIG. 1A, a source network node 110 and a target network node 120 are contained in the same RA1 that supports a network slice X for supporting a service requested by a UE 130. In scenario 102 as shown in FIG. 1B, the source network node 110 and the target network node 120 are contained in difference RAs, i.e., RA1 and RA2, which support the same network slice X. In both scenarios, the slice X provided by the target network node 120 suffers a high load. Due to this, the ongoing slice X of the UE cannot be served by the target network node 120 during a handover from the source network node 110 to the target network node 120.

In the above scenarios, upon receipt of a HO request from the source network node 110 and determining that the requested slice X is overloaded, the target network node 120 may transmit to the source network node 110 a HO Request Acknowledgement message for accepting the handover but rejecting the Slice X PDU session of the UE due to overload. In addition, other PDU session(s) may be admitted. In this way, the HO command will be provided immediately to the UE, and thus the likelihood of radio link failure is reduced. However, the PDU session for slice X will be released at the time of handover execution. As a result, the slice service continuity cannot be achieved.

The multi-carrier radio resource sharing solution may solve part of the above issue. In particular, the target network node 120 may act as a main node (MN) of the target network, and the slice X requested by the UE 130 can be supported by adding a target secondary node (SN). In particular, in a case where the target MN cannot support the PDU session of slice X due to overload, the target MN will add a corresponding target SN for supporting the slice X PDU session. This ensures that the UE can resume its PDU session for slice X during and after the handover from a source MN 110 to the target MN 120. However, the handover preparation will be delayed by configuring Dual Connectivity (DC) and adding the target SN, which may take about 40-50 ms. If the UE may have less time for a RRC configuration with DC preparation, the delay would be intolerable.

It has been also proposed to solve the above issue by utilizing a conditional handover (CHO) scheme. For example, a source node transmits CHO requests to both the target MN and one or more potential target SN. If the source node receives CHO request acknowledgement messages from the target MN and at least one target SN, it means that the target SN is added. The source node may then update the CHO command such that the CHO command includes both the target MN and the target SN configurations. In this way, the transmission of the CHO command would not be delayed by the SN addition procedure, and the UE resumes the PDU session of slice X if it receives the updated CHO command. However, when the source node receives the handover request ACK message indicating the PDU session of slice X is rejected, the source node may have no idea about whether or not it is able to send a second handover request through which the slice support can be provided with the addition of a target SN by the target MN.

As an example of the implementations, after receiving CHO request acknowledgement messages from the target MN and at least one target SN, the source node 110 transmits a CHO configuration to the UE 130. The target node 120 may then send a CHO cancel message to the source node 110, and indicate that it is modification related. Accordingly, the source node 110 will cancel the existing CHO configuration and transmits a new CHO request for providing a new CHO configuration. However, in this case, the target node 120 has to transmit an extra CHO cancel message to inform the source node 110 of providing another CHO configuration. In addition, since the source node 110 will always release the CHO configuration from the UE 130 after the CHO cancel message is received from the target node 120, this may causes an issue for mobility robustness.

As another example of the implementations, the source node 110 may reconfigure the UE 130 after a CHO has been configured. It is proposed that the source node 110 is informed, for example, by the target node 120 in the handover request acknowledgement message, of whether the target node 120 will keep the old UE configuration in parallel to the new UE configuration in case of a CHO modification via a new handover request. Based on this information, the source node 110 is able to decide to either directly transmit the new handover request without cancelling the CHO at the UE, or to cancel the CHO at the UE first and then to transmit the new handover request. This avoids failures due to potential race conditions, and it allows the UE to keep CHO configuration during the reconfiguration at the expense of extra signaling from the target MN 120 to the target SN. Furthermore, since the source node 110 is unaware about it is related to service continuity, the target node 120 may transmit an updated CHO configuration that is not related to slice continuity. As such, the source node 110 wouldn't know if the update is related CFRA (contention free random access) configuration or any other UE configuration, and it doesn't know that the slice support would be provided with the updated CHO.

In order to solve the above and other potential problems, embodiments of the present disclosure provide enhancements on slice service continuity. In the proposed solution, the source node informs the target node of urgency information about the HO. Accordingly, in the case where a requested service cannot be provided in a target cell, the target node can decide whether to ensure the service continuity via DC at the expense of delaying the HO, or to perform the HO immediately at the expense of service interruption based on this information. Moreover, the CHO scheme is improved in the proposed solution for supporting slicing and high service continuity, while providing mobility robustness to the UE.

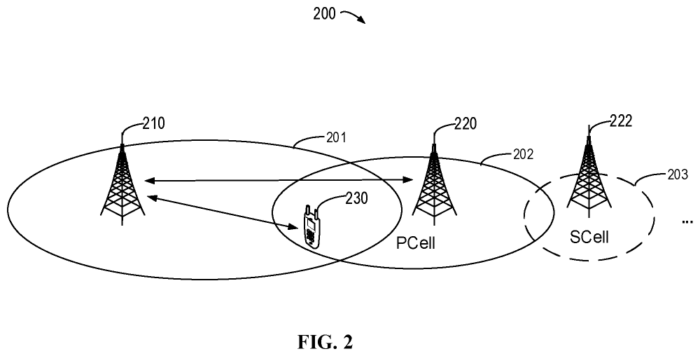

FIG. 2 illustrates an example network environment 200 in which embodiments of the present disclosure can be implemented. The network environment 200 includes a source network node 210, a target network node 220 and a UE 230.

As shown in FIG. 2, the source network node 210 is serving the UE 230 in the source cell 201 for a service associated with a network slice. The UE 230 may measure reference signals received from the source cell 201 and neighbor cells, e.g., the cell 202. The UE 230 then transmits the measurements to the source network node 210, for example, in a measurement report. The measurements may indicate a potential target cell for HO preparation, for example, the target network node 220. In addition, the source network node 210 may utilize machine learning (ML) algorithms and artificial intelligence (AI) technologies in estimating and analyzing the measurements.

In the above case, the source network node 210 may decide to perform the HO preparation with the target network node 220. For example, the source network node 210 may transmit a HO request to the target network node 220. The target network node 220 also supports the service associated with the ongoing network slice.

However, when the target network node 220 is overloaded for the on-going network slice of the UE 230, it cannot admit the slice. In other words, the target network node 220 only admits other PDU sessions corresponding to slices for which it does not have an overload. Accordingly, the target network node 220 may decide whether to perform the HO immediately at the expense of service continuity. Additionally, or alternatively, the target network node 220 can support the service via DC or via CA with a secondary network node 222 that provides a serving cell 203, which will be discussed in details below.

It should be understood that the network system 200 is given for illustrative purpose without suggesting any limitations. For example, the network system 200 can be implemented with additional devices or functions or interfaces not shown and/or omitting or replacing some of the devices or functions.

It should be also understood that the numbers of nodes, devices, and entities shown in FIG. 2 are given only for illustrative purpose without suggesting any limitations. For example, the network system 200 may include any suitable number of terminal devices and network devices adapted for implementing embodiments of the present disclosure. The present disclosure is not limited in this regard.

The communications in the network environment 300 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), a future sixth generation (6G) and/or any further communication protocols.

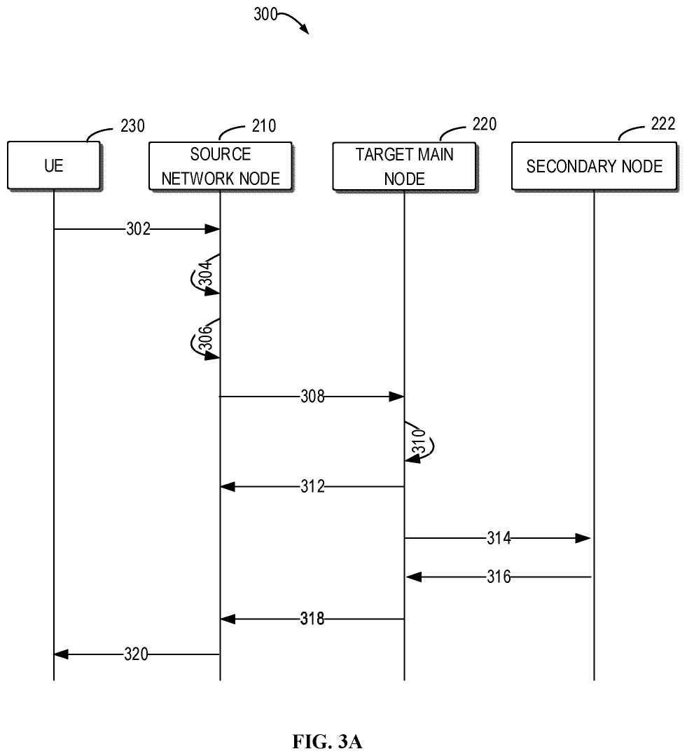

Principle and implementations of the present disclosure will be described in detail below with reference to FIGS. 3A and 3B. FIG. 3A shows a signaling chart illustrating a handover procedure 300 according to some example embodiments of the present disclosure. For the purpose of discussion, the process 300 will be described with reference to FIG. 2. The process 300 may involve the source network node 210, the target network node 220, the secondary network node 222 and the UE 230.

The measurement configuration is configured or preconfigured to the UE 230, such that it can measure reference signals from the source cell 201 and one or more neighbor cells (e.g., the cell 202) that may be operate on the same or different frequencies from cell 201.

The UE 230 transmits 302 a message comprising the measurements to the source network node 210. The message may be, for example, a measurement report, and the measurements may indicate a potential target cell 202 for HO preparation.

The source network node 210 makes 304 a HO decision based on the measurements. In some example embodiments, the source network node 210 may analyze based on the measurements, and determine 306 urgency of the HO for the UE 230. The analysis may be implemented by utilizing AI/ML technologies. The source network node 210 then transmits 308 a handover request indicating urgency of the handover to the target network node 220.

As discussed above, in the case that the target network node 220 is overloaded for the network slice X associated with the requested service, the target network node 220 may admit all the PDU sessions corresponding to slices that are not overloaded and reject the PDU session of slice X. Alternatively, the target network node 220 may establish a dual-connectivity with a secondary network node for supporting the slice X, that is, the secondary network node 222 is added in the secondary cell group (SCG). Information about the HO urgency is provided for facilitating the selection of the above two ways.

In some example embodiments, the urgency of the HO may be an indicator for indicating whether or not it is urgent handover request. It may be defined of different granularities. By way of example, a first indicator may indicate an urgent handover, while a second indicator may indicate a relaxed handover. By way of another example, the presence of an urgent indication may indicate the urgent handover, while the absence of the urgent indication may indicate the relaxed handover.

In some example embodiments, the urgency of the HO is based on whether or not there is time for a successful completion of HO after the serving cell 203 in the SCG is added by the target network node 220 for supporting the service. In other words, the HO urgency may be evaluated by if there is time for SN addition.

In some example embodiments, the urgency of the HO indicates a time budget for a successful completion of HO. For example, the time budget may indicate how much time the target network node 220 is to take for preparing the HO, for example, 20 ms for preparation.

In some example embodiments, the urgency of the handover may be based on measurements on reference signals from the UE 230. For example, the source network node 210 may measure at least one reference signal from the UE, and determine the urgency of the handover based on a result of the measurement, e.g., RSRP values. The determination can also be done by utilizing the AI/ML implementations to collect such information to indicate the HO urgency.

Upon receipt of the handover request, the target network node 220 determines 310 whether or not to apply multi-carrier radio resource sharing for supporting the service based on the urgency of the handover.

If the urgency of the handover indicates the urgent handover request, or there is no enough time for SN addition, the target network node 220 transmits 312 a handover request acknowledgement message indicating that PDU session of slice X is rejected. In this case, the multi-carrier radio resource sharing is inapplicable for the service.

Otherwise, if the urgency of the handover indicates the relaxed handover request, or there is enough time for SN addition, the target network node 220 transmits 314 a SN addition request to the secondary network node 222 for supporting the slice X PDU session. Upon receiving 316 a SN addition request acknowledgement message from the secondary network node 222, the dual-connectivity is established between the target network node 220 and the secondary network node 222. The target network node 220 then transmits 318 a handover request acknowledgement message with a DC configuration. Accordingly, the handover request acknowledgement message indicates that PDU session of slice X is provided over the secondary network node 222. In this case, the multi-carrier radio resource sharing is applicable for the service.

After receiving the handover request acknowledgement message, the source network node 210 transmits 320 a RRC reconfiguration message including the HO command to the UE 230.

According to the example embodiments, information about the HO urgency is provided for facilitating the handover procedure. The target MN uses this information to determine whether or not to apply multi-carrier radio resource sharing for supporting the requested service. Specifically, if the HO urgency indicates that a delay introduced by DC preparation cannot be tolerated with respect to the radio situation of the UE, the target network node 220 may transmit the handover request ACK message without adding the SN. Otherwise, if the delay is tolerable, the target network node 220 may first add the SN for supporting the requested slice X, and then transmit the HO handover request ACK message. In this way, a trade-off or a balance can be reached between a delay of handover and the slice service continuity. In addition, the service quality and mobility robustness can also be improved.

FIG. 3B shows a signaling chart illustrating a handover procedure 300 according to some example embodiments of the present disclosure. For the purpose of discussion, the process 330 will be described with reference to FIG. 2. The process 330 may involve the source network node 210, the target network node 220, the secondary network node 222 and the UE 230.

The measurement configuration is configured or preconfigured to the UE 230, such that it can measure reference signals from the source cell 201 and one or more neighbor cells (e.g., the cell 202) that may be operate on the same or different frequencies from cell 201.

The UE 230 transmits 332 a message comprising the measurements to the source network node 210. The message may be, for example, a measurement report, and the measurements may indicate a potential target cell 202 for CHO preparation.

The source network node 210 makes 334 a CHO decision based on the measurements. In some example embodiments, the source network node 210 may analyze based on the measurements, and the analysis may be implemented by utilizing AI/ML technologies. The source network node 210 then transmits 336 a first handover request to the target network node 220. The first handover request may indicate a serving cell 202 for supporting the slice X.

Since the slice X is overloaded over the target network node 220, the target network node 220 cannot admit the slice X. In addition, other PDU sessions corresponding to slices that are not overloaded can be admitted. Accordingly, the target network node 220 transmits 338 a first handover request acknowledgement message to the source network node 210.

The first handover request acknowledgement message may include an indication indicating that the requested service is not supported in the serving cell 202. This enable the source network device 210 to transmit a second handover request with an indication of CHO updates for the already existing CHO configuration.

In some example embodiments, the first handover request acknowledgement message may indicate that the slice service can be supported via DC, for example, with the same primary cell as requested by the source network node 210. Since the current configuration consists of only the configuration of the target network node 220 corresponding to the single connectivity, the configuration corresponding dual-connectivity is not yet provided in the current CHO configuration.

Additionally or alternatively, the first handover request acknowledgement message may indicate that the probability or likelihood of a successful DC. This information can be used by the source network node 210 to determine whether to transmit a second handover request to the target network node 220.

In some example embodiments, the first handover request acknowledgement message may indicate that the slice service can be supported through either DC or CA, but configured with a separate cell identity (e.g., NR-CGI or (new radio cell group identity) than the requested cell identity. For example, the first handover request indicates the serving cell 202 identified by a first cell identity, denoted by NR-CGI 1, and the first handover request acknowledgement message may include an indication of a second cell identity different from the planned first second cell identity, denoted by NR-CGI 2. Such an indication implies conditional slice continuity, and the target network node 220 implies an overlapping coverage of the second NR-CGI with CA or DC cells.

In some example embodiments, the first handover request acknowledgement message may indicate at least one frequency for SN addition to support the slice service. In other words, the target network node 220 indicates that the PDU Session of slice X can be supported via DC on a specific frequency. The source network node 210 may use this indication to setup specific configuration of measurement to the UE 230. As such, it will ensure that the SN related measurements will be available in a subsequent handover request (e.g., the second handover request). On the other hand, the target network node 220 can select a secondary network node based on these measurements. For example, the target network node 220 may determine to add a secondary network node that provides a serving cell with above threshold measurements. The target network node 220 may then transmit the SN addition request to the corresponding serving cell.

In some example embodiments, when obtaining the indication from the received first handover request acknowledgement message, the source network node 210 may not release the CHO configuration for the first serving cell identified by NR-CGI 1.

Upon obtaining the indication from the received first handover request acknowledgement message, the source network node 210 may transmit 340 a RRC reconfiguration with the CHO configuration to the UE 230.

The source network node 210 may determines 342 that the existing CHO configuration corresponding to single connectivity is not to be released, but a new handover request, e.g., the second handover request is to be transmitted for the same prepared NR-CGI 1.

In some example embodiments, the Source network node 210 may determine that the second handover request can be related to the NR-CGI 2 as indicated in the first handover request acknowledgement message.

The source network node 210 transmits 344 the second handover request with a CHO update notification. In some example embodiments, the source network node 210 may further indicate that the second handover request is tied to the first handover request that is previously transmitted to the target network node 220.

The source network node 210 may then initiate 346 early data transfer to the target network node 220, for example, by transmitting an early SN status transfer message.

The UE 230 may transmit 348 a RRC Reconfiguration complete message to the source network node 210.

The target network node 220 transmits 350 a SN addition request to the secondary network node 222 for adding the secondary network node 222. The secondary network node 222 transmits 352 a SN addition request acknowledgement message to the target network node 220.

Upon receipt of the SN addition request acknowledgement message, the target network node 220 transmits 354 a second handover acknowledgement message with the updated CHO configuration corresponding to dual connectivity to the source network node 210.

The source network node 210 transmits 356 a new RRC Reconfiguration to the UE 230 with the added secondary network node 222 that supports the slice X. The UE 230 may then transmit 358 the RRC Reconfiguration complete message to the source network node 210.

According to the example embodiments, there is provided an enhanced handover mechanism for supporting slice service. The proposed solution ensures that the UE has a valid CHO configuration while the target node is establishing DC for supporting an overloaded slice at target node via a secondary node. The target node may decide whether the UE would have time for a RRC configuration with DC preparation or not. The source node would be aware that the overloaded slice may be supported over a secondary node by a subsequent handover request.

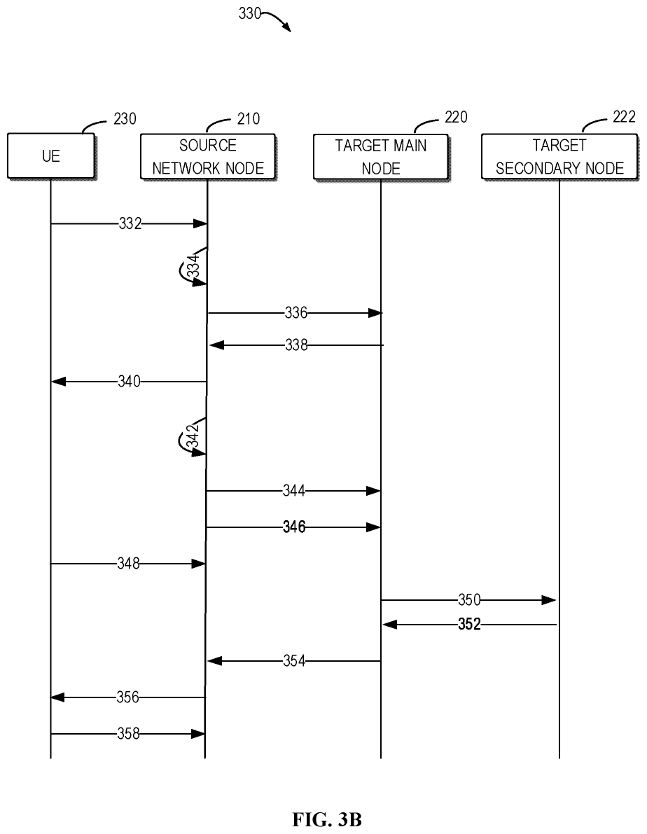

FIG. 4 illustrates a flowchart of an example method 400 for slice service continuity according to example embodiments of the present disclosure. The method 400 can be implemented at a source node, which may be, for example, the source network node 210 as shown in FIG. 2. For the purpose of discussion, the method 400 will be described with reference to FIG. 2. It is to be understood that method 400 may further include additional blocks not shown and/or omit some shown blocks, and the scope of the present disclosure is not limited in this regard.

At 410, the source network node 210 receives, from the UE 230, a message indicative of a target network node 220 for a handover of the UE 230 from the source network node 210 to the target network node 220. The UE 230 is being served by the source network node 210 for a service associated with a network slice X.

In some example embodiments, the message may be a measurement report that includes measurements by the UE 230 on transmissions of the service in more than one frequency band.

At 420, the source network node 210 transmits a handover request to the target network node 220. The handover request indicates urgency of the handover for the UE 230. The target network node 220 is overloaded for the network slice X.

In some example embodiments, the urgency of the handover may indicate whether or not there is time for a successful completion of the handover after a serving cell in a SCG is added by the target network node 220 for supporting the service.

In the above embodiments, the urgency of the handover may indicate a time budget needed for a successful completion of the handover, and the time budget indicates how much time the target network node 220 is to take for preparing the handover.

In some example embodiments, the source network node 210 may measure at least one reference signal from the UE 230. The source network node 210 may then determine the urgency of the handover based on a result of the measurement.

In some example embodiments, the urgency of the handover may be indicated by one of the following:
a first indicator for indicating an urgent handover, while a second indicator for indicating a relaxed handover; or
a presence of an urgent indication indicating the urgent handover, while an absence of the urgent indication indicating the relaxed handover.

At 430, the source network node 210 receives a handover request acknowledgement message from the target network node 220. The handover request acknowledgement message indicates if multi-carrier radio resource sharing is applicable for supporting the service.

In some example embodiments, the handover request acknowledgement message may indicate that the multi-carrier radio resource sharing is applicable for supporting the service by indicating a serving cell in a SCG added by the target network node 220 for supporting the service.

In some example embodiments, the handover request acknowledgement message may include at least one of following:
a cell identity of the serving cell, and
a frequency used by the target network node 220 for supporting the multi-carrier radio resource sharing.

In some example embodiments, the handover request acknowledgement message may indicate that the multi-carrier radio resource sharing is not applicable for supporting the service by indicating a rejection of supporting the service with the overloaded network slice.

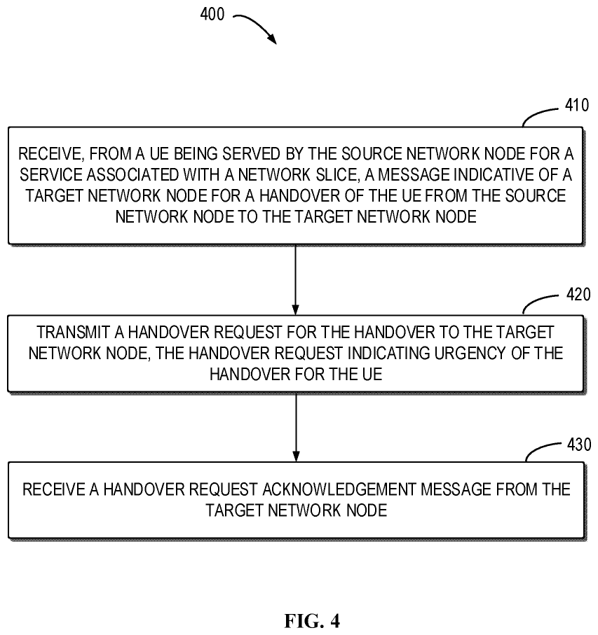

FIG. 5 illustrates a flowchart of an example method 500 for slice service continuity according to example embodiments of the present disclosure. The method 500 can be implemented at a target node, which may be, for example, the target network node 220 as shown in FIG. 2. For the purpose of discussion, the method 500 will be described with reference to FIG. 2. It is to be understood that method 500 may further include additional blocks not shown and/or omit some shown blocks, and the scope of the present disclosure is not limited in this regard.

At 510, the target network node 220 receives, from the source network node 210, a handover request indicating urgency of the handover for the UE 230. The source network node 210 is serving the UE 230 for a service associated with a network slice X, and the target network node 220 is overloaded for the network slice X.

At 520, the target network node 220 determines whether or not to apply multi-carrier radio resource sharing for supporting the service based on the urgency of the handover.

In some example embodiments, the urgency of the handover may indicate whether or not there is time for a successful completion of the handover after a serving cell in a SCG is added by the target network node 220 for supporting the service. The serving cell may include one of a primary secondary cell or a secondary cell in the SCG.

In some example embodiments, the urgency of the handover may indicate a time budget needed for a successful completion of the handover. The time budget may indicate how much time the target network node 220 is to take for preparing the handover.

In some example embodiments, the urgency of the handover may be determined based on measurements by the source network node 210 on at least one reference signal from the UE 230.

In some example embodiments, the urgency of the handover may be indicated by one of the following:
a first indicator for indicating an urgent handover, while a second indicator for indicating a relaxed handover; or
a presence of an urgent indication indicating the urgent handover, while an absence of the urgent indication indicating the relaxed handover.

In some example embodiments, if the urgency of the handover indicates an urgent handover, the target network node 220 may determine that the multi-carrier radio resource sharing is not applicable. Otherwise, if the urgency of the handover indicates a relaxed handover, the target network node 220 may determine that the multi-carrier radio resource sharing is applicable.

At 530, the target network node 220 transmits, to the source network node 210, a handover request acknowledgement message indicating if the multi-carrier radio resource sharing is applicable for the service.

In some example embodiments, if the multi-carrier radio resource sharing is not applicable, the target network node 220 may transmit the handover request acknowledgement message indicating a rejection of supporting the service with the overloaded network slice. Otherwise, if the multi-carrier radio resource sharing is applicable, the target network node 220 may transmit the handover request acknowledgement message indicating a serving cell in a secondary cell group added by the target network node for supporting the service.

In some example embodiments, the handover request acknowledgement message may include at least one of following:
a cell identity of the serving cell, and
a frequency used by the target network node 220 for supporting the multi-carrier radio resource sharing.

In some example embodiments, the serving cell is added or is to be added by the target network node 220 by using at least one of carrier aggregation and dual connectivity.

In some example embodiments, the serving cell is provided by at least one of the target network node 220 and a secondary node 222 connected to the target network node 220 with an Xn interface in a dual connectivity scheme.

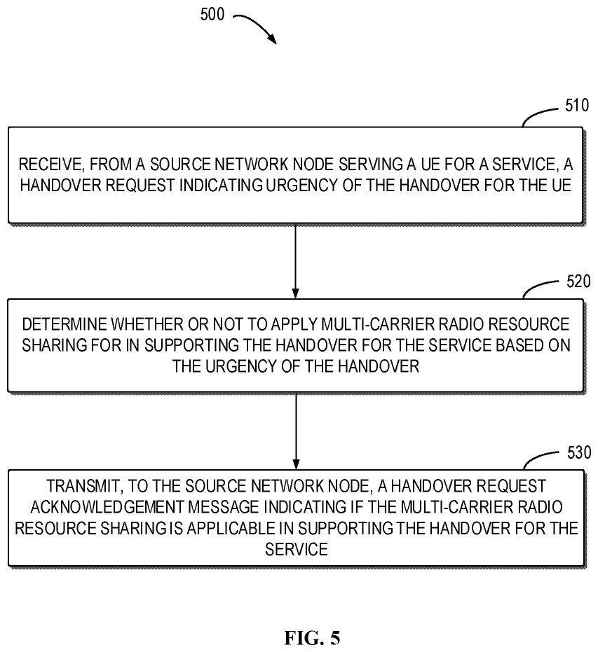

FIG. 6 illustrates a flowchart of an example method 600 for slice service continuity according to example embodiments of the present disclosure. The method 600 can be implemented at a source node, which may be, for example, the source network node 210 as shown in FIG. 2. For the purpose of discussion, the method 600 will be described with reference to FIG. 2. It is to be understood that method 600 may further include additional blocks not shown and/or omit some shown blocks, and the scope of the present disclosure is not limited in this regard.

At 610, the source network node 210 receives, from the UE 230, a message indicative of the target network node 220 for a handover from the source network node 210 to the target network node 220. The UE 230 is being served by the source network node 210 for a service associated with a network slice X.

In some example embodiments, the message the message may include a measurement report comprising measurements by the UE on transmissions of the service in more than one frequency band.

At 620, the source network node 210 transmits, to the target network node 220, a first handover request indicating a first serving cell 202 of the target network node 220 for supporting the network slice X.

At 630, upon receipt a first handover request acknowledgement message from the target network node, the source network node 210 determines that the service is not supported in the first serving cell 202 based on an indication of the first handover request acknowledgement message.

In some example embodiments, the indication may indicate that the service is to be supported by dual connectivity with the second serving cell 203 in a SCG.

In some example embodiments, the indication may include a likelihood of the service to be supported by dual connectivity with the second serving cell in a secondary cell group.

In the above embodiments, the source network node 210 may determine whether to transmit the second handover request to the target network node based on the likelihood.

In some example embodiments, the indication may indicate that the service is to be supported by the second serving cell 203 different from the first serving cell 202, and the second serving cell 203 is provided by the target network node or provided by a further network node 222 as a secondary cell.

In the above embodiments, upon receipt of the indication, the source network node 210 may determine not to release a conditional handover configuration for the first serving cell 202.

In some example embodiments, the indication may indicate frequencies used for supporting the multi-carrier radio resource sharing with the second serving cell 203. In these embodiments, the source network node 210 may determine a configuration of measurement reporting based on the frequencies, and transmit the configuration of measurement reporting to the UE 230.

At 640, the source network node 210 transmits, to the target network node 220, a second handover request indicating a second serving cell 203 for supporting the network slice X.

At 650, the source network node 210 receives, from the target network node 220, a second handover request acknowledgement message comprising a handover configuration corresponding to the second serving cell 203 that supports the network slice X.

In some example embodiments, the first handover request may include a first cell identifier associated with a first serving cell supporting the service, and the first handover request acknowledgement message may include a second cell identifier associated with a second serving cell supporting the service.

In some example embodiments, the second handover request may be transmitted with a handover update notification, and the second handover request acknowledgement message may include an updated configuration of conditional handover related to the first serving cell and the second serving cell. The second handover request may indicate an association with the first handover request.

In some example embodiments, the second serving cell may be one of a primary secondary cell or a secondary cell.

In some example embodiments, the serving cell is provided by at least one of the target network node 220 and a secondary node 222 connected to the target network node 220 with an Xn interface in a dual connectivity scheme.

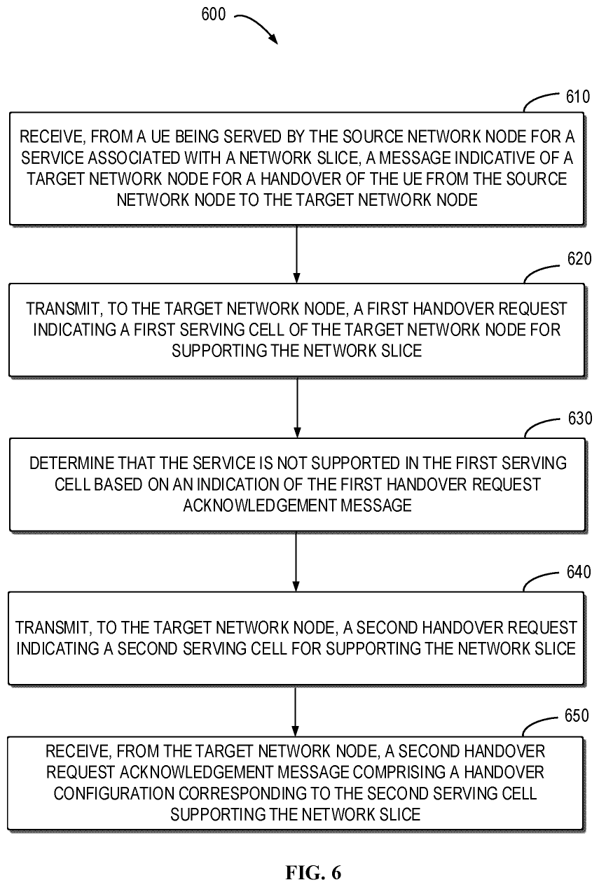

FIG. 7 illustrates a flowchart of an example method 700 for slice service continuity according to example embodiments of the present disclosure. The method 700 can be implemented at a target node, which may be, for example, the target network node 220 as shown in FIG. 2. For the purpose of discussion, the method 700 will be described with reference to FIG. 2. It is to be understood that method 700 may further include additional blocks not shown and/or omit some shown blocks, and the scope of the present disclosure is not limited in this regard.

At 710, the target network node 220 receives, from the source network node 210, a first handover request indicating a first serving cell (e.g., the cell 202) of the target network node 220 for supporting the network slice X. The source network device 210 is serving the UE 230 for a service associated with the network slice X.

Since the slice X is overloaded at the target network node 220, the service may not be supported over the slice X. At 720, the target network node 220 transmits, to the source network node 210, a first handover request acknowledgement message. The first handover request acknowledgement message may include an indication indicating that the service associated with the network slice X is not to be supported in the first serving cell 202.

At 730, the target network node 220 receives, from the source network node 210, a second handover request indicating a second serving cell 203 for supporting the network slice X.

At 740, the target network node 220 transmits, to the source network node 210, a second handover request acknowledgement message comprising a handover configuration corresponding to the second serving cell 203 that supports the network slice X.

In some example embodiments, the indication may indicate that the service is to be supported by dual connectivity with the second serving cell 203 in a SCG.

In some example embodiments, the indication may indicate a likelihood of the service to be supported by dual connectivity with the second serving cell 203 in a SCG.

In some example embodiments, the indication may indicate that the service is to be supported by the second serving cell 203 different from the first serving cell 202, and the second serving cell 203 may be provided by at least one of the target network node 220 and a further network node 222 as a secondary cell.

In some example embodiments, the first handover request acknowledgement message may indicate frequencies used for supporting the multi-carrier radio resource sharing with the second serving cell 203.

In some example embodiments, the first handover request may include a first cell identifier associated with a first serving cell 202 supporting the network slice X, and the first handover request acknowledgement message may include a second cell identifier associated with a second serving cell 203 supporting the network slice X.

In some example embodiments, the second handover request may be received with a handover update notification, and the second handover request acknowledgement message may be an updated configuration of conditional handover related to the first serving cell 202 and the second serving cell 203. The second handover request may indicate an association with the first handover request.

In some example embodiments, the second serving cell 203 may be one of a primary secondary cell or a secondary cell.

In some example embodiments, the serving cell is provided by at least one of the target network node 220 and a secondary node 222 connected to the target network node 220 with an Xn interface in a dual connectivity scheme.

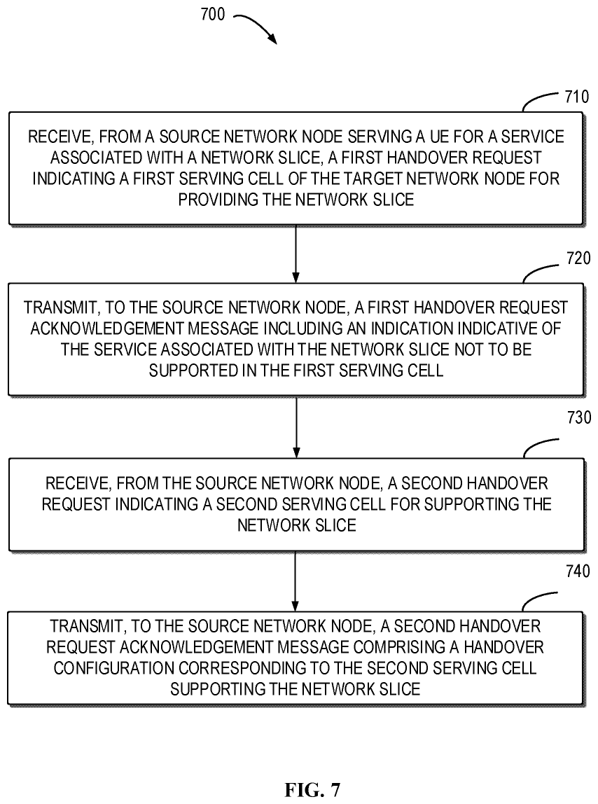

FIG. 8 illustrates a flowchart of an example method 800 for slice service continuity according to example embodiments of the present disclosure. The method 800 can be implemented by a terminal device, which may be, for example, the UE 230 as shown in FIG. 2. It is to be understood that method 800 may further include additional blocks not shown and/or omit some shown blocks, and the scope of the present disclosure is not limited in this regard.

At 810, the UE 230 transmits, to the source network node 210, a message indicative of the target network node 220 for a handover of the UE 230 from the source network node 210 to the target network node 220 for a service. The UE 230 is served by the source network node 210 for the service associated with a network slice X.

At 820, the UE 230 receives, from the source network node 210, a handover command indicating continuity of the service via multi-carrier radio resource sharing.

At 830, the UE 230 receives the service via a serving cell using multi-carrier radio resource sharing based on the handover command.

In some example embodiments, the serving cell is provided by at least one of the target network node 220 and another network node (e.g., the secondary network node 222) in dual connectivity over Xn interface with the target network node 220.

In some example embodiments, a source apparatus capable of performing any of the method 400 (for example, the source network node 210) may comprise means for performing the respective steps of the method 400. The means may be implemented in any suitable form. For example, the means may be implemented in a circuitry or software module.

In some example embodiments, the source apparatus comprises: means for receiving, from a user equipment, UE, being served by the source apparatus for a service associated with a network slice, a message indicative of a target apparatus for a handover of the UE from the source apparatus to the target apparatus; means for transmitting a handover request to the target apparatus, the handover request indicating urgency of the handover for the UE, and the target apparatus being overloaded for the network slice; and means for receiving a handover request acknowledgement message from the target apparatus, the handover request acknowledgement message indicating if multi-carrier radio resource sharing is applicable for supporting the service.

In some example embodiments, the urgency of the handover indicates whether or not there is time for a successful completion of the handover after a serving cell in a secondary cell group is added by the target apparatus for supporting the service.

In some example embodiments, the urgency of the handover indicates a time budget needed for a successful completion of the handover, and the time budget indicates how much time the target apparatus is to take for preparing the handover.

In some example embodiments, the source apparatus further comprises: means for measuring at least one reference signal from the UE; and means for determining the urgency of the handover based on a result of the measurement.

In some example embodiments, the urgency of the handover is indicated by one of the following: a first indicator for indicating an urgent handover, while a second indicator for indicating a relaxed handover; or a presence of an urgent indication indicating the urgent handover, while an absence of the urgent indication indicating the relaxed handover.

In some example embodiments, the handover request acknowledgement message indicates that the multi-carrier radio resource sharing is applicable for supporting the service by indicating a serving cell supporting the network slice in a secondary cell group is added by the target apparatus.

In some example embodiments, the handover request acknowledgement message indicates that the multi-carrier radio resource sharing is not applicable for supporting the service by indicating a rejection of supporting the service associated with the overloaded network slice.

In some example embodiments, the message comprises a measurement report comprising measurements by the UE on transmissions of the service in more than one frequency band.

In some example embodiments, a target apparatus capable of performing any of the method 500 (for example, the target network node) may comprise means for performing the respective steps of the method 500. The means may be implemented in any suitable form. For example, the means may be implemented in a circuitry or software module.

In some example embodiments, the target apparatus comprises: means for receiving, from a source apparatus serving a user equipment, UE, for a service associated with a network slice, a handover request indicating urgency of the handover for the UE, the target apparatus being overloaded for the network slice; means for determining whether or not to apply multi-carrier radio resource sharing for supporting the service based on the urgency of the handover; and means for transmitting, to the source apparatus, a handover request acknowledgement message indicating if the multi-carrier radio resource sharing is applicable for the service.

In some example embodiments, the urgency of the handover indicates whether or not there is time for a successful completion of the handover after a serving cell supporting the network slice in a secondary cell group is added by the target apparatus for supporting the service.

In some example embodiments, the urgency of the handover indicates a time budget needed for a successful completion of the handover, and the time budget indicates how much time the target apparatus is to take for preparing the handover.

In some example embodiments, the urgency of the handover is determined based on measurements by the source apparatus on at least one reference signal from the UE.

In some example embodiments, the target apparatus further comprises: means for in accordance with a determination of an urgent handover, determining that the multi-carrier radio resource sharing is not applicable; or means for in accordance with a determination of a non-urgent handover, determining that the multi-carrier radio resource sharing is applicable.

In some example embodiments, the target apparatus further comprises: means for in accordance with a determination that the multi-carrier radio resource sharing is not applicable for supporting the service, transmitting the handover request acknowledgement message indicating a rejection of supporting the service associated with the overloaded network slice; or means for in accordance with a determination that the multi-carrier radio resource sharing is applicable for supporting the service, transmitting the handover request acknowledgement message indicating a serving cell supporting the network slice in a secondary cell group is added by the target apparatus.

In some example embodiments, the serving cell comprises one of a primary secondary cell or a secondary cell in the secondary cell group.

In some example embodiments, the serving cell is added or is to be added by the target apparatus using at least one of carrier aggregation and dual connectivity.

In some example embodiments, the serving cell is provided by at least one of the target apparatus and a secondary node connected to the target apparatus with an Xn interface in a dual connectivity scheme.

In some example embodiments, a source apparatus capable of performing any of the method 600 (for example, the source network node 210) may comprise means for performing the respective steps of the method 600. The means may be implemented in any suitable form. For example, the means may be implemented in a circuitry or software module.

In some example embodiments, the source apparatus comprises: means for receiving, from a user equipment, UE, being served by the source apparatus for a service associated with a network slice, a message indicative of a target apparatus for a handover of the UE from the source apparatus to the target apparatus; means for transmitting, to the target apparatus, a first handover request indicating a first serving cell of the target apparatus for supporting the network slice; means for upon receipt a first handover request acknowledgement message from the target apparatus, determining that the service is not supported in the first serving cell based on an indication of the first handover request acknowledgement message; means for transmitting to the target apparatus, a second handover request indicating a second serving cell for supporting the network slice; and means for receiving, from the target apparatus, a second handover request acknowledgement message comprising a handover configuration corresponding to the second serving cell.

In some example embodiments, the indication is indicative of the service is to be supported by dual connectivity with the second serving cell in a secondary cell group.

In some example embodiments, the indication is indicative of a likelihood of the service to be supported by dual connectivity with the second serving cell in a secondary cell group.

In some example embodiments, the indication is indicative of the service is to be supported by the second serving cell different from the first serving cell, and the second serving cell is provided by at least one of the target apparatus and a further secondary apparatus as a secondary cell.

In some example embodiments, the source apparatus further comprises: means for upon receipt of the indication, determining not to release a conditional handover configuration for the first serving cell.

In some example embodiments, the first handover request acknowledgement message indicates frequencies used for supporting the multi-carrier radio resource sharing.

In some example embodiments, the source apparatus further comprises: means for determining a configuration of measurement reporting based on the frequencies; and means for transmitting, to the UE, the configuration of measurement reporting.

In some example embodiments, the message comprises a measurement report comprising measurements by the UE on transmissions of the service in more than one frequency band.

In some example embodiments, the first handover request comprises a first cell identifier associated with the first serving cell supporting the network slice, and the first handover request acknowledgement message comprises a second cell identifier associated with the second serving cell supporting the network slice.

In some example embodiments, the second handover request is transmitted with a handover update notification, and the second handover request acknowledgement message comprises an updated configuration of conditional handover related to the first serving cell and the second serving cell.

In some example embodiments, the second handover request indicates an association with the first handover request.

In some example embodiments, the second serving cell comprises one of a primary cell or a secondary cell.

In some example embodiments, the serving cell is provided by at least one of the target apparatus and a secondary node connected to the target apparatus with an Xn interface in a dual connectivity scheme.

In some example embodiments, a target apparatus capable of performing any of the method 700 (for example, the target network node 220) may comprise means for performing the respective steps of the method 700. The means may be implemented in any suitable form. For example, the means may be implemented in a circuitry or software module.

In some example embodiments, the target apparatus comprises: means for receiving, at a target apparatus and from a source apparatus serving a user equipment, UE, for a service associated with a network slice, a first handover request indicating a first serving cell of the target apparatus for supporting the network slice; means for transmitting, to the source apparatus, a first handover request acknowledgement message including an indication indicative of the service associated with the network slice not to be supported in the first serving cell; means for receiving, from the source apparatus, a second handover request indicating a second serving cell for supporting the network slice; and means for transmitting, to the source apparatus, a second handover request acknowledgement message comprising a handover configuration corresponding to the second serving cell supporting the network slice.

In some example embodiments, the indication is indicative of the service is to be supported by dual connectivity with the second serving cell in a secondary cell group.

In some example embodiments, the indication is indicative of a likelihood of the service to be supported by dual connectivity with the second serving cell in a secondary cell group.

In some example embodiments, the indication is indicative of the service is to be supported by a second serving cell different from the first serving cell, and the second serving cell is provided by the target apparatus or provided by a further apparatus as a secondary cell.

In some example embodiments, the first handover request acknowledgement message indicates frequencies used for supporting the multi-carrier radio resource sharing.

In some example embodiments, the first handover request comprises a first cell identifier associated with the first serving cell supporting the network slice, and the first handover request acknowledgement message comprises a second cell identifier associated with the second serving cell supporting the network slice.

In some example embodiments, the second handover request is received with a handover update notification, and wherein the second handover request acknowledgement message comprises an updated configuration of conditional handover related to the first serving cell and the second serving cell.

In some example embodiments, the second handover request indicates an association with the first handover request.

In some example embodiments, the second serving cell comprises one of a primary secondary cell or a secondary cell.

In some example embodiments, the serving cell is provided by at least one of the target apparatus or a secondary node connected to the target apparatus with an Xn interface in a dual connectivity scheme.

In some example embodiments, an apparatus capable of performing any of the method 800 (for example, the target network node 220) may comprise means for performing the respective steps of the method 800. The means may be implemented in any suitable form. For example, the means may be implemented in a circuitry or software module.

In some example embodiments, the apparatus comprises means for transmitting, to a source apparatus serving the UE for a service associated with a network slice, a message indicative of a target apparatus for a handover of the UE from the source apparatus to the target apparatus for the service; means for receiving, from the source apparatus, a handover command indicating continuity of the service via multi-carrier radio resource sharing; and means for receiving the service via a serving cell using multi-carrier radio resource sharing based on the handover command.

In some example embodiments, the serving cell is provided by at least one of the target apparatus and another apparatus in dual connectivity over Xn interface with the target apparatus.

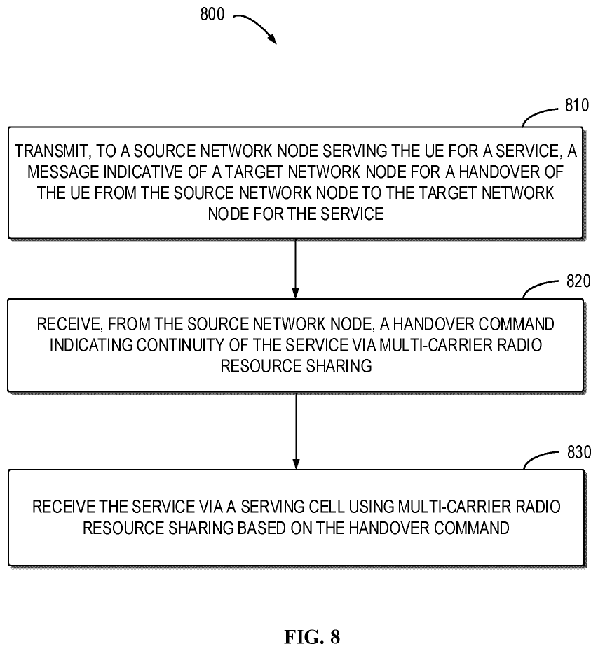

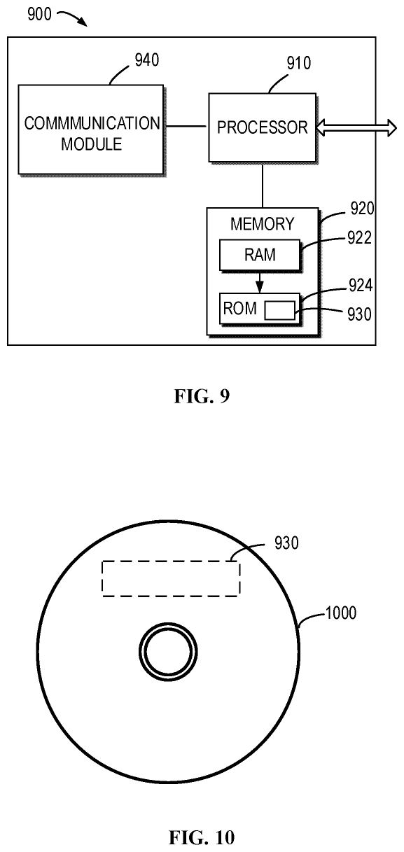

FIG. 9 is a simplified block diagram of a device 900 that is suitable for implementing embodiments of the present disclosure. The device 900 may be provided to implement the communication device, for example, the source network node 210, the target network node 220, the secondary network node 222 and the UE 230 as shown in FIG. 2. As shown, the device 900 includes one or more processors 910, one or more memories 920 coupled to the processor 910, and one or more transmitters and/or receivers (TX/RX) 940 coupled to the processor 910.

The TX/RX 940 may be configured for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 922 and other volatile memories that will not last in the power-down duration.

A computer program 930 includes computer executable instructions that may be executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 1000 may perform any process of the disclosure as discussed with reference to FIGS. 3A and 3B. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 9 shows an example of the computer readable medium 1000 in form of CD or DVD. The computer readable medium has the program 930 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 to 800 as described above with reference to FIGS. 4 to 8. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-52. (canceled)

53. A source network node, comprising:
at least one processor; and
at least one memory including computer program codes;
the at least one memory and the computer program codes are configured to, with the at least one processor, cause the source network node at least to:
receive, from a user equipment, UE, being served by the source network node for a service associated with a network slice, a message indicative of a target network node for a handover of the UE from the source network node to the target network node;
transmit a handover request to the target network node, the handover request indicating urgency of the handover for the UE, and the target network node being overloaded for the network slice; and
receive a handover request acknowledgement message from the target network node, the handover request acknowledgement message indicating if multi-carrier radio resource sharing is applicable for supporting the service.

54. The source network node according to claim 53, wherein the urgency of the handover indicates whether or not there is time for a successful completion of the handover after a serving cell in a secondary cell group is added by the target network node for supporting the service.

55. The source network node according to claim 53, wherein the urgency of the handover indicates a time budget needed for a successful completion of the handover, and the time budget indicates how much time the target network node is to take for preparing the handover.

56. The source network node according to claim 53, wherein the at least one memory and the computer program codes are configured to, with the at least one processor, further cause the source network node to:
measure at least one reference signal from the UE; and
determine the urgency of the handover based on a result of the measurement.

57. The source network node according to claim 53, wherein the urgency of the handover is indicated by one of the following:
a first indicator for indicating an urgent handover, while a second indicator for indicating a relaxed handover; or
a presence of an urgent indication indicating the urgent handover, while an absence of the urgent indication indicating the relaxed handover.

58. The source network node according to claim 53, wherein the handover request acknowledgement message indicates that the multi-carrier radio resource sharing is applicable for supporting the service by indicating a serving cell supporting the network slice in a secondary cell group is added by the target network node.

59. The source network node according to claim 53, wherein the handover request acknowledgement message indicates that the multi-carrier radio resource sharing is not applicable for supporting the service by indicating a rejection of supporting the service with the overloaded network slice.

60. The source network node according to claim 53, wherein the message comprises a measurement report comprising measurements by the UE on transmissions of the service in more than one frequency band.

61. A target network node, comprising:
at least one processor; and
at least one memory including computer program codes,
the at least one memory and the computer program codes configured to, with the at least one processor, cause the target network node at least to:
receive, from a source network node serving a user equipment, UE, for a service associated with a network slice, a handover request indicating urgency of the handover for the UE, the target network node being overloaded for the network slice;
determine whether or not to apply multi-carrier radio resource sharing for supporting the service based on the urgency of the handover; and
transmit, to the source network node, a handover request acknowledgement message indicating if the multi-carrier radio resource sharing is applicable for the service.

62. The target network node according to claim 61, wherein the urgency of the handover indicates whether or not there is time for a successful completion of the handover after a serving cell supporting the network slice in a secondary cell group is added by the target network node for supporting the service.

63. The target network node according to claim 61, wherein the urgency of the handover indicates a time budget needed for a successful completion of the handover, and the time budget indicates how much time the target network node is to take for preparing the handover.

64. The target network node according to claim 61, wherein the urgency of the handover is determined based on measurements by the source network node on at least one reference signal from the UE.

65. The target network node according to claim 61, wherein the at least one memory and the computer program codes configured to, with the at least one processor, cause the target network node to determine whether to apply the multi-carrier radio resource sharing by:
in accordance with a determination of an urgent handover, determining that the multi-carrier radio resource sharing is not applicable; or
in accordance with a determination of a non-urgent handover, determining that the multi-carrier radio resource sharing is applicable.

66. The target network node according to claim 65, wherein the at least one memory and the computer program codes configured to, with the at least one processor, cause the target network node to transmit the handover request acknowledgement message by:
in accordance with a determination that the multi-carrier radio resource sharing is not applicable for supporting the service, transmitting the handover request acknowledgement message indicating a rejection of supporting the service with the overloaded network slice; or
in accordance with a determination that the multi-carrier radio resource sharing is applicable for supporting the service, transmitting the handover request acknowledgement message indicating a serving cell supporting the network slice in a secondary cell group is added by the target network node.

67. The target network node according to claim 62, wherein the serving cell comprises one of a primary secondary cell or a secondary cell in the secondary cell group.

68. The target network node according to claim 62, wherein the serving cell is added or is to be added by the target network node using at least one of carrier aggregation and dual connectivity.

69. The target network node according to claim 62, wherein the serving cell is provided by at least one of the target network node and a secondary node connected to the target network node with an Xn interface in a dual connectivity scheme.

70. A user equipment, UE, comprising:
at least one processor; and
at least one memory including computer program codes;
the at least one memory and the computer program codes are configured to, with the at least one processor, cause the UE at least to:
transmit, to a source network node serving the UE for a service associated with a network slice, a message indicative of a target network node for a handover of the UE from the source network node to the target network node for the service;
receive, from the source network node, a handover command indicating continuity of the service via multi-carrier radio resource sharing; and
receive the service via a serving cell using multi-carrier radio resource sharing based on the handover command.

71. The UE of claim 70 wherein the serving cell is provided by at least one of the target network node and another network node in dual connectivity over Xn interface with the target network node.
